(19) United States
(12) Patent Application Publication
(10) Pub. No.: US 2023/0202111 A1
(43) Pub. Date: Jun. 29, 2023

(54) PRINTER INERTIZATION UNITS

(71) Applicants: Emilio Carlos Cano Arribas, Sant Cugat del Valles (ES); Sergi Culubret Contade, Sant Cugat del Valles (ES); Ignacio Alejandra Femandes, Sant Cugat del Valles (ES); Esteve Comas Cespedes, Sant Cugat del Valles (ES)

(72) Inventors: Emilio Carlos Cano Arribas, Sant Cugat del Valles (ES); Sergi Culubret Contade, Sant Cugat del Valles (ES); Ignacio Alejandra Femandes, Sant Cugat del Valles (ES); Esteve Comas Cespedes, Sant Cugat del Valles (ES)

(21) Appl. No.: 16/608,398

(22) PCT Filed: Mar. 7, 2018
(86) PCT No.: PCT/US18/21289

§ 371 Date: Oct. 25, 2019

(51) Int. Cl. B29C 64/371; B33Y 30/00; B33Y 40/00; H01M 8/0662; H01M 8/04291; H01M 8/1009

(52) U.S. Cl. CPC B29C 64/371; B33Y 30/00; B33Y 40/00; H01M 8/0662; H01M 8/04291; H01M 8/1009; H01M 2250/10

(57) ABSTRACT

It is disclosed a printing system comprising: a print unit and an inertization unit; wherein the print unit is associated to a print chamber being the print chamber to receive print material from a source and the print unit to print the print material within the print chamber and wherein the inertization unit comprises a fuel-cell coupled to a fuel storage and an oxidant fluid input being the oxidant fluid input fluidly connected to the print chamber.

### BACKGROUND

Printers are devices wherein a print material is processed to generate a printed object. Further additive manufacture systems, commonly known as three-dimensional (3D) printers, enable objects to be generated on a layer-by-layer basis.

Powder-based 3D printing systems, for example, form successive layers of a print material in a printer such print material is often referred to as build material. Then, the printer selectively solidifies portions of the build material to form layers of the object or objects being generated. Such selective solidification may include, amongst others, selectively fusing part of the print material and/or selectively binder part of the build material.

Two-dimensional and three-dimensional printers often comprise a print chamber wherein print material is placed and is processed to generate a printed object, e.g., adding a printing fluid, selectively fusing some of the print material, etc.

### BRIEF DESCRIPTION OF THE DRAWINGS

Examples will now be described, by way of non-limiting example only, with reference to the accompanying drawings, in which:

FIG. 1 shows a schematic representation of a printing system comprising an inertization unit according to an example.

FIG. 2 shews an example of a printing system comprising an inertization unit with a hydrogen fuel-cell.

FIG. 3 shows an example of a printing system comprising an inertization unit with a methanol fuel-cell.

FIG. 4 shows an example of a printing system comprising an inertization unit with a metal-air fuel-cell.

FIG. 5 shows a method for inertization of a chamber according to an example.

FIG. 6 shows an example of a method for inertization of a chamber and determining the amount of oxygen of the chamber according to an example.

### DETAILED DESCRIPTION

Printing systems may be used to generate different types of printed output, thereby obtaining different types of products. For example, in a 2D printer a substrate is used as print material and the result is a modified substrate containing information printed on it.

Furthermore, in a 3D printer, a build material may be used as print material and, in that case, a selective solidification of the build material by means of a selective solidification unit generates a three-dimensional object. In particular, such selective solicitation may be accomplished, for example, by selective laser sintering or stereo-lithography.

Therefore, selective solidification units can include one or several of: print fluid ejectors, heaters, lasers, build material ejectors, electron beam generators, etc.

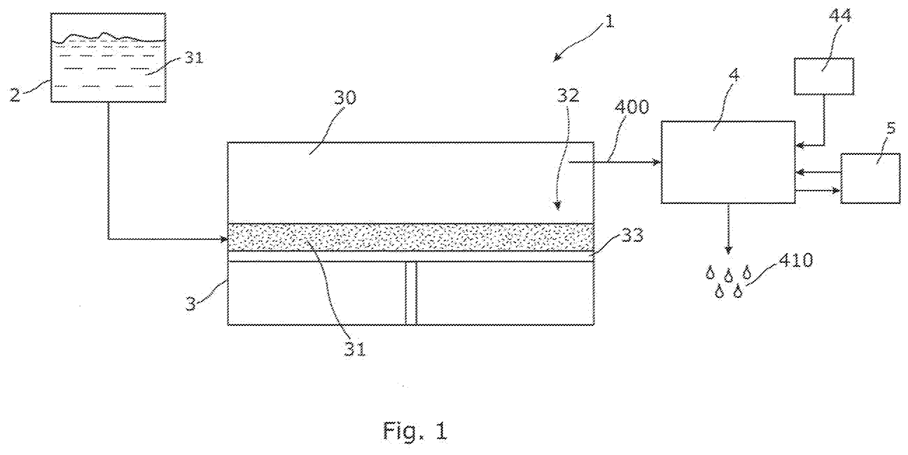

FIG. 1 shows an example of a printing system 1 wherein the system comprises a print unit 3 and a print chamber 30 with a print surface 33 wherein the print surface 33 is to, in use, receive the print material 31 from a print material storage 2. The print chamber 30 may be defined as the chamber wherein the print material 31 is located and subject to at least part of a printing process by a selective solidification unit 32, e.g., printing agent ejection, laser sintering, laser fusion, heating, curing, etc.

The print chamber 30 of FIG. 1 may be part of the print unit 3. Also, the print unit 3 may be to receive a removable print chamber 30 to perform a printing operation on a print surface 33 associated to such print unit 3 and/or print chamber 30.

In an example, the print surface 33 may be a print surface for a 2D printer thereby acting as a supporting surface for a substrate or a conveyor unit. In this example, the storage 2 may be, e.g., a roll or a stack of substrate that is fed to the print chamber 30 by means of a media handling device, e.g., a set of rollers.

In a further example, the print surface 33 may be a build platform of a 3D printer wherein the print surface 33 is moved downwards as a 3D object is generated, e.g., by selectively solidifying successive layers of the print material 31. In this case, the print material 31 may be, e.g., a powder and the transfer of the powder from the storage 2 to the print chamber 30 may be done by a pump, conveyor belts, augers or the like. In this case, the printing fluid may be a printing liquid, such as a fusing agent and/or a detailing agent that is ejected towards the build material to enhance or prevent its selective solidification.

The presence of oxygen in the print chamber 30 may generate unwanted effects. For example, in inkjet printers (for example, 2D printers) wherein a UV curable ink is used, the curing may be performed by free-radical polymerization. The presence of oxygen in the print chamber may scavenge the free radicals and produce unreactive peroxide radicals that may result in tacky, uncured surfaces Further, in some 3D printers the presence of oxygen in the build chamber may oxide the print material 31 which results in poorly solidified portions of such material.

In some printing systems, the print chamber 30 is exposed to atmospheric air in which the presence of oxygen is of around 21%. In an example of a printing system, the amount of oxygen to substantially decrease unwanted effects may be below 10% or, in a further example, below 1%.

To decrease the amount of oxygen inside the print chamber 30, the printing system 1 may comprise an inertization unit 4. The inertization unit 4 is fluidly connected to the print chamber 30 thereby establishing a flew channel through which an oxidant fluid 400 (an oxygen-containing fluid) flows from the print chamber 30 towards the inertization unit 4. In an example, the oxidant fluid may be the air within the print chamber 30.

The inertization unit 4 may comprise a fuel-cell that reacts with at least part of the oxygen within the oxidant fluid 400 thereby effectively reducing the amount of oxygen in the oxidant fluid 400 and, in consequence, also in the print chamber 30. Fuel-cells are chemical cells wherein an electrochemical reaction between a fuel and an oxidizing agent generates a flow of electrons. In the example of FIG. 1, the oxidant fluid 400 may be used as the oxidizing agent for the fuel-cell and the fuel may be provided from a fuel storage 44 and can be, e.g., hydrogen, methanol, methane, a metal, etc. Further, the inertization unit 4 may generate a waste fluid 410 and, in some cases, heat as a result of the chemical reactions therein.

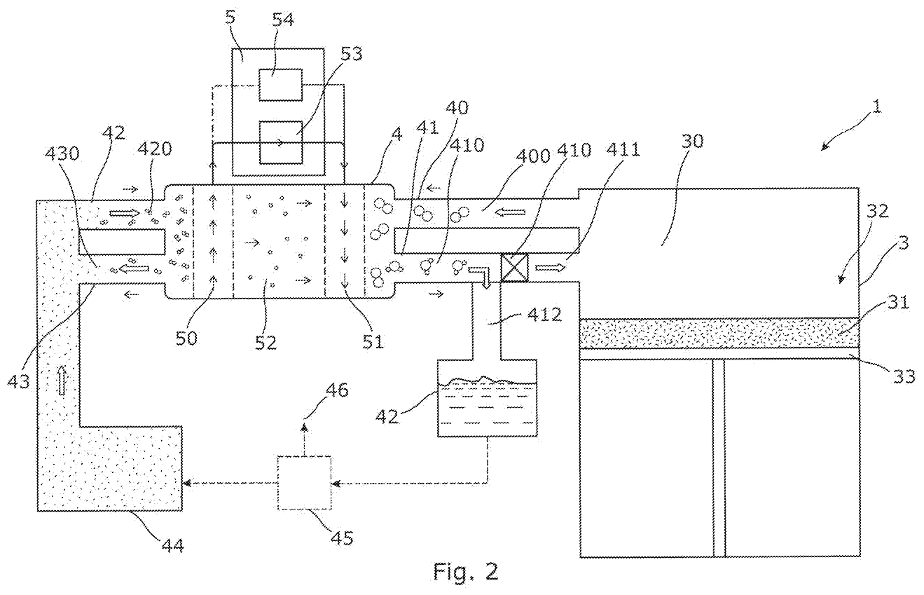

FIG. 2 shows an example of printing system 1 wherein hydrogen is used as fuel to the fuel-cell of the inertization unit 4. In this example, hydrogen 420 is stored in the fuel storage 44 and is fed through a fuel inlet 42 to the fuel-cell. The print chamber 30 also comprises an oxidant fluid 400 that is fed through an oxidant inlet 40 to the fuel-cell.

The fuel-cell comprises an electrolyte 52, and anode 50 and a cathode 52. At the anode 50 a catalyst oxidizes the hydrogen turning it into positively charged ions and a negatively charged electron, the electrolyte 52 allows ions to pass towards the cathode 51 wherein such ions react with oxygen present in the oxidizing fluid 400 and generate a waste fluid 410. Also, the negatively charged electrons flow from anode 50 to cathode 51 thereby generating a flow of electrons.

The chemical reactions within the fuel-cell generate, on the fuel side, excess hydrogen 430 through a fuel outlet 43 that may be feedback to the fuel inlet 42 and, on the oxidant fluid side, a waste fluid 410 through a waste outlet 41. The waste fluid may be steam that can be separated into water 410 and an oxygen-depleted gas 411, e.g., by means of a membrane 410 that allows gas to pass and such oxygen-depleted gas may be fed to the build chamber 30. The injection of such oxygen-depleted gas 411 back to the print chamber 30 lowers the amount of oxygen contained therein.

In an example, the print chamber 30 may be a sealed, or a substantially sealed, chamber to prevent atmospheric air to enter the print chamber 30, thereby reducing the amount of oxygen from atmospheric air that enters the print chamber 30.

Also, as shown in FIG. 2, the water 412 that results from the waste fluid 410 may be processed to generate hydrogen and, therefore, to provide it as fuel for the fuel-cell.

Water may be stored in a water storage 42 that may be fluidly connected to a hydrogen separator 45 wherein hydrogen is obtained and transferred, e.g., to the fuel storage 44 or to the fuel inlet 42. In an example, the hydrogen separator 45 may be a reversed fuel-cell, wherein a current is provided between anode and cathode and water is fed as fuel to obtain hydrogen and waste oxygen 46 that may be released to the atmosphere.

In a further example, the fuel-cell of the inertization unit 4 may be used as a hydrogen separator to replenish hydrogen to the fuel storage 44. In an example, when a controller 5 determines, using an oxygen detector 53, that the oxygen level within the print chamber 30 is below an oxygen threshold, the fuel-cell of the inertization unit is reversed, i.e., a current is applied between the anode 50 and the cathode 51 (a current is applied instead of having an oxygen detector 53) by a source 54 and water is provided through the fuel inlet 42 thereby obtaining hydrogen on the oxidant fluid inlet 40. Such reversion of the fuel-cell may be performed, e.g., by means of controllable valves provided on the fuel inlet 42 the water storage 42 (or any other water source) and the oxidant fluid inlet 40 controllable by the controller 5. The controller 5 may also be to control? whether between the anode 50 and the cathode 51 an oxygen detector 53 is connected or a source 54 is connected. This control may be performed by means of switches and/or transistors.

Also, the fuel-cell within the inertization unit 4 may be used to determine an estimation of the concentration of oxygen within the print chamber 30. Since the flow of electrons between the anode 50 and the cathode 51 depends on the amount of oxygen obtained by the fuel-cell, in particular, from the oxidant fluid 400, a lower flow of electrons is indicative of a lower presence of oxygen in the oxidant fluid 400 and, therefore, in the print chamber 30. Therefore, an oxygen detector 53 may be connected between the anode and the cathode being such oxygen detector 53 to measure the flow of electrons and determine, in view of such flow, the amount of oxygen left in the print chamber 30. Such an oxygen detector may be connected to the controller 5 to determine, e.g., if the fuel-cell of the inertization unit 4 should be turned-off by shutting the hydrogen flow from the hydrogen storage 44 thereby optimizing the use of hydrogen.

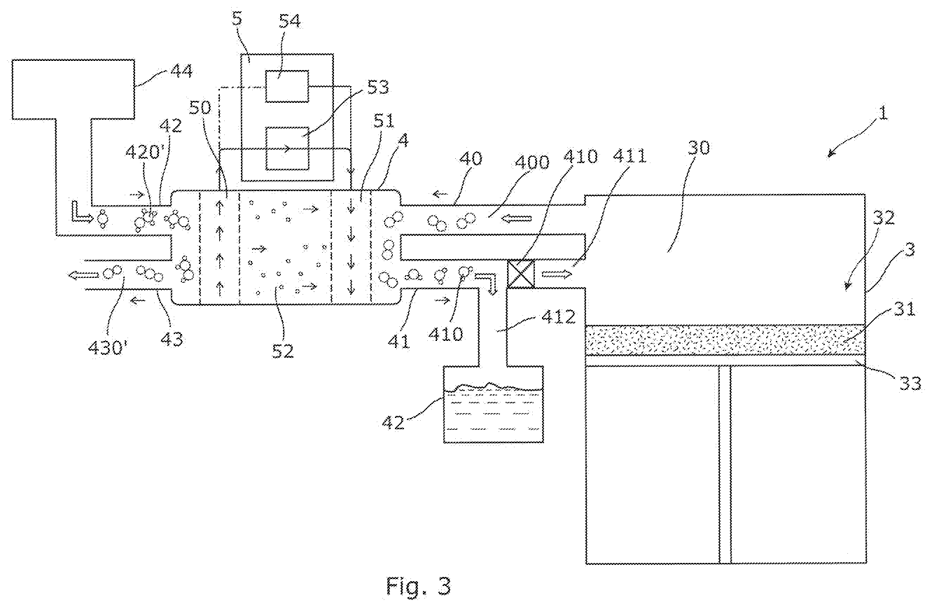

FIG. 3 shows a further example wherein the inertization unit 4 is a methanol fuel-cell, i.e., a fuel-cell wherein methanol 420′ is used as fuel and is input to the fuel-cell through the fuel inlet 42. The chemical reaction with the fuel-cell generates a waste, in this case, CO₂ 430′ that may be released through the fuel outlet 43 towards a further device for Its processing or to the atmosphere. In an example, the CO₂ 430′ may also be fed back to the build chamber to reduce the concentration of oxygen within the print chamber 30.

On the oxidant side, as in the case of FIG. 2 wherein hydrogen is used as fuel, an oxidant fluid 400 is retrieved from the print chamber 30 and some of the oxygen within the oxidant fluid 400 reacts with the fuel-cell obtaining, a waste fluid 410, for example, a steam that may be separated into water 42 and an oxygen depleted gas 411 that may be fed to the build chamber 30. In an example, water 42 may be stored for other processes within the printer 1 such as e.g., fluid delivery systems, heating systems and/or cooling systems.

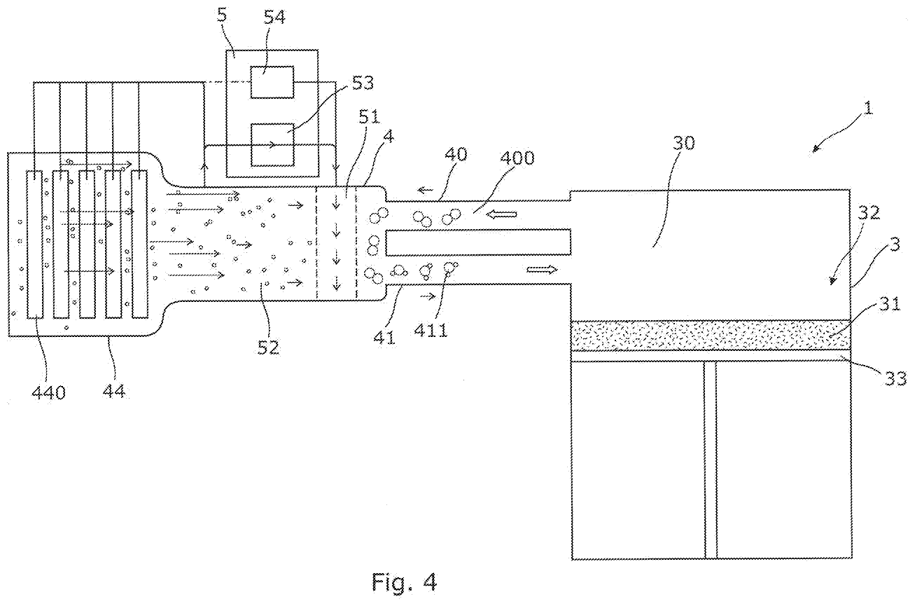

FIG. 4 shows a further example of a printing device 1 comprising an inertization unit 4 that, in this case, is a metal-air fuel-cell.

Metal-air fuel-cells are fuel-cells that use a metal (for example, zinc or aluminium) as fuel for the chemical reaction and wherein the metal is used as the electrode. In the example of figure 4 it is shown that the inertization unit 4 comprises a fuel storage 44 wherein a set of zinc plates 440 are stored. A metal 440 is used as fuel and reacts with the oxidant fluid 400 in the presence of an electrolyte 52 to generate an electron flow between the metal 440 (which acts as the anode) and the cathode 51.

As a result of such reaction an oxygen-depleted gas 411 is obtained that may be fed to the print chamber 30 and the zinc plates 440 oxidize.

Once oxygen is below a determined level within the print chamber 30, the fuel-cell may be reversed to regenerate the zinc plates 440. The operation of the metal-air fuel-cell resembles the operation of a rechargeable battery wherein a metal plate is oxidized when the battery is supplying energy and, upon reversal, the metal is regenerated by receiving energy from an energy source.

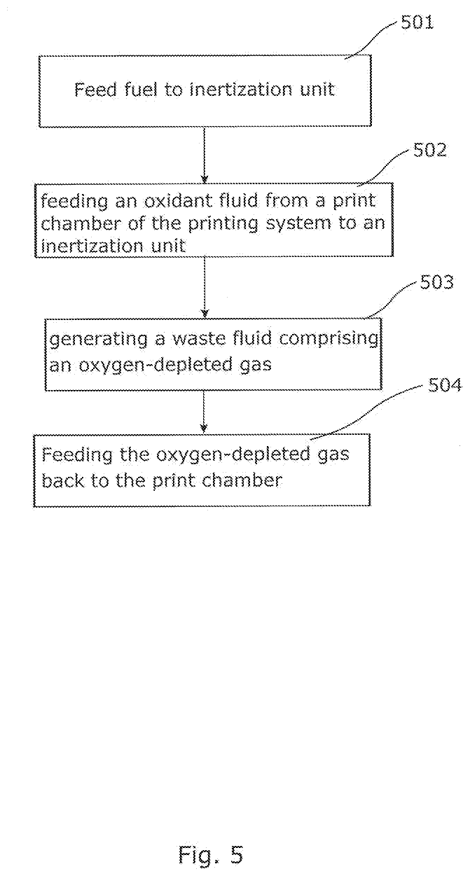

FIG. 5 shows a method for inertization of a print chamber within a printing system. In the example of FIG. 5, a fuel-cell is provided and coupled to a print chamber. The fuel-cell is to be fed with a fuel 501, e.g., hydrogen, methanol or a metal as explained above.

Also, the fuel-cell is fed with an oxidant fluid from the print chamber 502. Then, the fuel-cell reacts with the hydrogen and oxygen from the oxidant fluid and, as a result, generates a waste fluid 503 wherein such waste fluid comprises an oxygen-depleted gas and may also comprise water and/or steam.

Finally, the oxygen-depleted gas is fed to the print chamber 504 thereby reducing the overall concentration of oxygen within the print chamber.

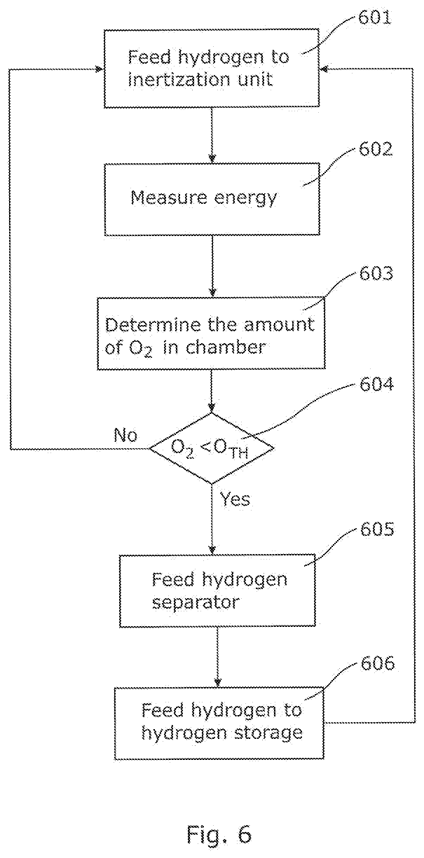

FIG. 6 shows an example of a print chamber inertization method according to an example. In the method of FIG. 6, an inertization unit comprising a fuel-cell is fed with a fuel 601 on its fuel side, e.g., hydrogen. Also, the inertization unit is provided to receive an oxidant fluid on the oxidant side, therefore, the fuel-ceil is fed, on the fuel side with a fuel and on the oxidant side with a fluid containing oxygen, also referred to as an oxidant fluid.

A reaction occurs on the fuel-cell wherein the fuel reacts with the oxygen present in the oxidant fluid generating a flow of electrons between the anode and the cathode of the fuel-cell and waste fluids such as, e.g., excess hydrogen on the fuel side and a waste fluid that may be separated into water and an oxygen depleted fluid. The flow of electron is an energy that may be measured 602, e.g., by determining the magnitude of the flow of electrons generated by the reaction within the fuel-cell. Since this energy is proportional to the amount of oxygen on the oxidant fluid and, therefore, on the print chamber, it can be used to determine the amount of oxygen left inside the print chamber 603.

A controller may then determine if the oxygen level is below a pre-defined threshold (Oₜₕ) 604 and, if it is not, the fuel continues to be fed to the fuel-cell as to consume more oxygen within the print chamber, if the oxygen level is below the determined threshold, e.g., less 10% oxygen or less than 1% of oxygen is left on the print chamber, a hydrogen separator 605 may be energized as to generate hydrogen to be used as fuel and such hydrogen may be stored in the hydrogen storage 606.

To generate hydrogen, the fuel-cell may be reversely-operated to work as a hydrogen separator. In this mode of operation, a controller is to feed an electron flow between the anode and the cathode of the fuel-cell and water may additionally be fed to the fuel-cell to generate hydrogen. As a result the oxidant inlet becomes a hydrogen output that may be coupled to the hydrogen storage.

In particular, it is disclosed a printing system comprising:
a print chamber; and
an inertization unit;
   wherein the print unit is associated to a print chamber being the print chamber to receive print material from a source and the print unit to print the print material within the print chamber and wherein the inertization unit comprises a fuel-cell coupled to a fuel storage and an oxidant fluid input being the oxidant fluid input fluidly connected to the print chamber.

In an example, the fuel-cell is to receive hydrogen, methanol or a methane flow, e.g., by a fuel-inlet coupled to a fuel storage or comprise a metal chamber wherein a metal is located to be used as an electrode for a metal fuel-cell. In any case, other types of fuels are to be considered as equivalents to a person skilled in the art.

In an example, the fuel-cell wherein the fuel-cell generates a waste fluid and comprises a waste fluid outlet, the waste fluid comprising an oxygen depleted gas and wherein the fuel-cell is to feed, at least, the oxygen depleted gas to the print chamber. The waste fluid may be filtered as to feed only the oxygen-depleted gas back to print chamber, such filtering may be performed, e.g., by a membrane configured to allow the gas to pass to the print chamber and prevent water from passing and such membrane may be associated to an outlet of water coupled to a water storage, in this case, fuel-cell is to feed the water to a water storage.

In a further example, the fuel-cell comprises a hydrogen separator coupled to the water storage being the hydrogen separator to output hydrogen through a hydrogen output. The hydrogen separator may be an electrolyzer or a reversely-operated fuel-cell to act as a hydrogen generator.

The fuel input may be, e.g., coupled to the hydrogen output of the hydrogen separator.

Furthermore, the fuel-cell may comprise an anode and a cathode to provide a flow of electrons between the anode and the cathode and wherein the system comprises an oxygen detector and a controller associated to the oxygen detector to determine the oxygen level within the print chamber in view of the flow of electrons.

The printing system, as disclosed may be, e.g., an inkjet printer wherein the print unit comprises a printhead that is to print using a UV curable ink. In this case, the print chamber may comprise a UV cure zone wherein ink or any printing fluid deposited on a print material is subjected to an UV radiation as to polymerize the printing fluid for curing and/or drying of inks, adhesives, coatings or any other printing fluid. In this environment, the presence of oxygen in the cure zone may affect the curing process, therefore, the oxidant fluid input may be connected to the UV cure zone thereby reducing the amount of oxygen within the cure zone.

In another example, the printer is a three-dimensional printer wherein the print chamber is provided with an inertization unit to lower the amount of oxygen on the print chamber which reduces the possibility and/or the amount of build material oxidation.

Also, it is disclosed an inertization unit for a printer, the inertization unit being a fuel-cell that comprises:
an oxidant fluid inlet;
an anode and a cathode; and
   wherein the printer defines a print chamber where print material Is printed, being the oxidant fluid inlet to be fluidly connected to the print chamber as to, in use, feed oxidant fluid from the print chamber to the inertization unit. In an example, the inertization unit comprises an oxygen detector that is to be connected to the anode and the cathode being the oxygen detector to determine an oxygen level within the print chamber in view of the flow of electrons between the anode and the cathode.

In an example, the printer is an inkjet printer or a three-dimensional printer.

Additionally, it is disclosed an inertization method that comprises:
feeding an oxidant fluid from a print chamber of the printing system to an inertization unit comprising a fuel-cell;
feeding a fuel to the fuel-cell;
obtaining a waste fluid from the fuel-cell, the waste fluid comprising an oxygen depleted gas; and
feeding the oxygen depleted gas to the print chamber

The oxidant fluid may be, e.g., the air within the build chamber that may container around a 21% of oxygen. The method may further comprise obtaining from the fuel-cell a flow of electrons and determining, by a controller, an oxygen level within the print chamber based on the flow of electrons.

1. A printing system comprising:
a print unit; and
an inertization unit;
wherein the print unit is associated to a print chamber being the print chamber to receive print material from a source and the print unit to print the print material within the print chamber and wherein the inertization unit comprises a fuel-cell coupled to a fuel storage and an oxidant fluid input being the oxidant fluid input fluidly connected to the print chamber.

2. The system of claim 1, wherein the fuel-cell is to receive hydrogen, methanol or a methane flow from the fuel storage or to comprise a metal electrode.

3. The system of claim 1, wherein the fuel-cell generates a waste fluid and comprises a waste fluid outlet, the waste fluid comprising an oxygen depleted gas and wherein the fuel-cell is to feed, at least, the oxygen depleted gas to the print chamber.

4. The system of claim 3 wherein the fuel cell generates a waste fluid comprising water and wherein the fuel-cell is to feed the water to a water storage.

5. The system of claim 4 wherein the inertization unit comprises a hydrogen separator coupled to the water storage being the hydrogen separator to output hydrogen through a hydrogen output.

6. The system of claim 5, wherein the fuel input is coupled to the hydrogen output of the hydrogen separator.

7. The system of claim 1, wherein the fuel-cell comprises an anode and a cathode to provide a flow of electrons between the anode and the cathode and wherein the inertization unit comprises an oxygen detector associated to a controller to determine an oxygen level within the print chamber in view of the flow of electrons.

8. The system of claim 1, wherein the printer is an inkjet printer.

9. The system of claim 7, wherein the print unit comprises a print head to print using an UV curable ink.

10. The system of claim 8, wherein the print chamber comprises an UV cure zone and the oxidant fluid input is connected to the UV cure zone.

11. The system of claim 1, wherein the printer is a three-dimensional printer.

12. An inertization unit for a printer, the inertization unit being a fuel-cell that comprises:
an oxidant fluid inlet;
an anode and a cathode; and
wherein the printer defines a print chamber where print material is printed, being the oxidant fluid inlet to be fluidly connected to the print chamber as to, in use, feed oxidant fluid from the print chamber to the inertization unit.

13. The inertization unit of claim 12 wherein the inertization unit comprises an oxygen detector and and wherein the oxygen detector is connected to the anode and the cathode being the oxygen detector to determine an oxygen level within the print chamber in view of the flow of electrons between the anode and the cathode.

14. An inertization method for a printing system, wherein the inertization method comprises:
feeding an oxidant fluid from a print chamber of the printing system to an inertization unit comprising a fuel-cell;
feeding a fuel to the fuel-cell;
obtaining a waste fluid from the fuel-cell, the waste fluid comprising an oxygen depleted gas; and
feeding the oxygen depleted gas to the print chamber

15. The method of claim 14 wherein the method comprises obtaining from the fuel-cell a flow of electrons and, by a controller, determining an oxygen level within the print chamber based on the flow of electrons.
